(19) United States
(12) Patent Application Publication
(10) Pub. No.: US 2016/0004373 A1
(43) Pub. Date: Jan. 7, 2016

(54) METHOD FOR PROVIDING AUXILIARY INFORMATION AND TOUCH CONTROL DISPLAY APPARATUS USING THE SAME

(71) Applicant: UNIMICRON TECHNOLOGY CORP., TAOYUAN HSIEN (TW)

(72) Inventor: HAN-PEI HUANG, TAOYUAN COUNTY (TW)

(21) Appl. No.: 14/542,809

(22) Filed: Nov. 17, 2014

(30) Foreign Application Priority Data
Jul. 7, 2014 (TW) 103123325

(51) Int. Cl. G06F 3/041

(52) U.S. Cl. CPC G06F 3/0416

(57) ABSTRACT

A method for providing auxiliary information and touch control display apparatus using the same are provided. The method includes steps as following. An operating signal is received, and whether the operating signal is an auxiliary information request signal is determined. When the operating signal is an auxiliary information request signal, the auxiliary information of an object is presented, wherein the object corresponds to a coordinate of the auxiliary information request signal on the touch-control screen.

### BACKGROUND OF THE INVENTION

1. Field of the Invention

The instant disclosure relates to a touch control display; in particular, to a method for providing auxiliary information adapted to the touch control display apparatus.

2. Description of Related Art

The development of touch control technology, specifically the touch-control screen, is becoming widely implemented in different consumer electronic apparatus, such as in the portable smart phone, tablet PC, camera, e-book, media player and the like, or in operation control equipment.

The touch-control screen implemented in the electronic apparatus can provide the user with a touch control display interface, most of which can be a graphic user interface (GUI). In graphic user interface, icons are usually displayed to represent the corresponding application or the corresponding file. The user can select the icon through the finger or a stylus to execute the application (App) or open the file corresponding to the selected icon.

Compared with a conventional operating interface, some disadvantages of the touch control display interface result in poor convenience in use. For example, in conventional operating interface, the user can move the mouse cursor to indicate and stay in a specific icon to obtain auxiliary information related to the application or the file corresponding to the selected icon before executing the application or opening the file. The auxiliary information can be the function of the application or the version information of the application.

However, when using the touch control display interface, the user only can deduce the application or the file corresponding to the icon according to the image of the icon and a simple description below the icon, but cannot obtain more detail auxiliary information related to the application or the file. As such, the only thing that user can do is to directly select the icon and wait for the application or the file corresponding to the selected icon to be executed or opened to further determine whether the executed application or the opened file is the desire application or file. When the user finds out the executed application or file corresponding to the selected icon is not the desirable application, the user has to reselect another possible icon to find out the desirable application or file. That is, the user can only use trial and error to search the desirable application or file. Accordingly, it can be inconvenient for the user to use the conventional touch control display interface.

Nowadays, a mode setting of the touch control display interface can be executed through two-step touch control, i.e., the auxiliary information related to the application or the file corresponding to the selected icon can be previewed through the first-step touch control, and the application or the file corresponding to the icon can be further executed or opened through the second-step touch control. For example, when the communication application is executed, the image or information can be previewed through the first-step touch control, and message transmission or download are executed through the second-step touch control. However, the function of the two-step touch control is limited because it is only executed in the application, and is not capable of being widely implemented in the other applications or files unless the application is modified step by step.

### SUMMARY OF THE INVENTION

The object of the instant disclosure is to provide a method for providing auxiliary information and a touch control display apparatus using the same. The method and the touch control display apparatus of the instant disclosure can allow the user to preview the auxiliary information of an application object or a file object before the object is opened, i.e., the application object is executed or the file object is opened, by the user.

In order to achieve the aforementioned objects, according to an embodiment of the instant disclosure, a method for providing auxiliary information, which is executed in a touch control display apparatus having a touch-control screen, includes the steps of receiving an operating signal and determining whether the operating signal is an auxiliary information request signal. When the operating signal is the auxiliary information request signal, an auxiliary information of an object is displayed, in which the object is corresponding to a coordinate at the touch-control screen where the auxiliary information is generated.

According to an embodiment of the instant disclosure, a touch control display apparatus is provided. The touch control display apparatus includes a touch-control screen and a processing unit. The touch-control screen is used to display an object. The processing unit is electrically connected to the touch-control screen to receive and process an auxiliary information request signal. The processing unit controls the touch control display to display an auxiliary information corresponding to the object. The object corresponds to a coordinate at the touch-control screen where the auxiliary information is generated.

In summary, the method for providing auxiliary information according to one embodiment of the instant disclosure can be executed in a touch control display apparatus having a touch-control screen. In addition, through the specific operating method, the auxiliary information corresponding to the object can be displayed to the user before the object is opened or executed. Accordingly, the user can determine whether selecting the object according to the auxiliary information of the object. In brief, the convenience for the user can be improved through the method for providing auxiliary information during the operation of the touch control display interface.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a function block diagram of a touch control display apparatus for providing auxiliary information according to an embodiment of the instant disclosure;

FIG. 2 shows a flow chart of a method for providing auxiliary information according to an embodiment of the instant disclosure;

FIG. 3 shows a flow chart for determining whether the operating signal is an auxiliary information request signal according to an embodiment of the instant disclosure;

FIGS. 4A and 4B show a flow chart for determining whether the operating signal is an auxiliary information request signal according to another embodiment of the instant disclosure;

FIG. 5 shows a flow chart for determining whether the operating signal is an auxiliary information request signal according to another embodiment of the instant disclosure;

FIG. 6 shows a lateral view of the touch control display apparatus shown in FIG. 1 in use state;

FIG. 7 shows a schematic diagram of the touch control display apparatus in which the method for providing auxiliary information is executed according to an embodiment of the instant disclosure.

FIG. 8 shows a schematic diagram of the touch control display apparatus in which the method for providing auxiliary information is executed according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner. In addition, the same reference numerals are given to the same or similar components.

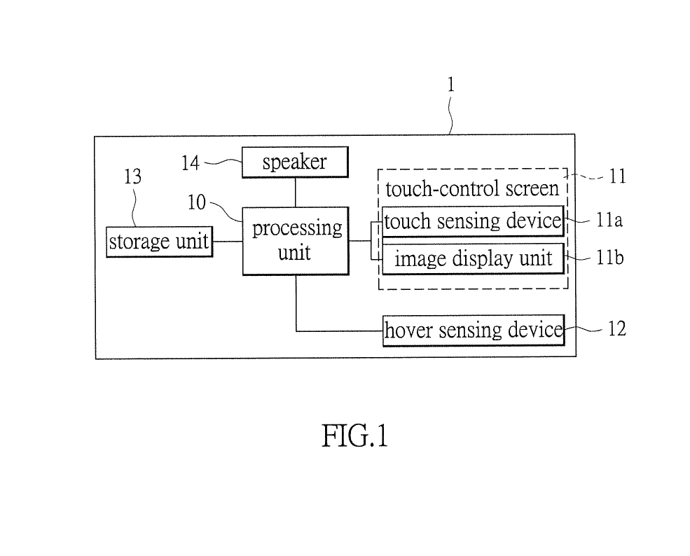

Please refer to FIG. 1, which illustrates a function block diagram of a touch control display apparatus for providing auxiliary information according to an embodiment of the instant disclosure. In the embodiment of the instant disclosure, the touch control display apparatus 1 includes a processing unit 10, a touch-control screen 11, a hover sensing device 12 and a storage unit 13, in which the processing unit 10 is electrically connected to the touch-control screen 11, the hover sensing device 12, and the storage unit 13 through wires. However, the means for establishing the signal communication are not limited in the instant disclosure.

Before the user selects an object to execute the application or open the file corresponding to the object, the touch control display apparatus 1 is capable of providing auxiliary information corresponding to an object. The touch control display apparatus 1 determines whether an operating signal is an auxiliary information request signal or just a touch signal in order to further determine whether the auxiliary information is to be provided. For example, the auxiliary information of the object is displayed on a screen or provided by a voice message. The object corresponds to a coordinate, at which the auxiliary information request signal is generated on the touch control display apparatus 1.

The processing unit 10 can receive the operating signal inputted by the user through the touch-control screen 11 or the hover sensing device 12, as well as determine and analyze the operating signal. Specifically, after receiving the operating signal, the processing unit 10 can determine the operating signal is a touch signal from the touch-control screen 11 or a hover signal form the hover sensing device 12. In the instant embodiment, the processing unit 10 receives a coordinate of the hover signal on the touch-control screen 11 from the hover sensing device 12 and determines whether the coordinate falls within a display range of the object presented on the touch-control screen 11. When the coordinate of the hover signal on the touch-control screen 11 falls within the display range of the object presented on the touch-control screen 11, the processing unit 10 determines the hover signal is the auxiliary information request signal of the object.

The processing unit 10 can include one or more processors, controllers, microprocessor, microcontroller, application-specific integrated circuit, digital signal processor, programmable logic device (PLD), field programmable gate array (FPGA) and memory or any combination thereof. However, the instant disclosure is not limited to the type of the processing unit 10.

The touch-control screen 11 is used to display image and allow a touch operation to be performed by the user. That is, the touch-control screen 11 can serve as a touch control display interface. The touch-control screen 11 can display a corresponding image, which can optionally include at least one object, according to the control of the processing unit 10 and display the auxiliary information of the object. Specifically, the touch-control screen 11 includes a touch sensing device 11a and an image display unit 11b, both of which are electrically connected to the processing unit 10.

The image display unit 11b is capable of displaying a static or dynamic image and can be a liquid crystal display unit or an e-paper, but the instant disclosure is not limited to the type of the image display unit 11b. In the embodiment of the instant disclosure, the image display unit 11b is used to selectively display at least one object. The object can be an application object, a file object, a toolbar or an icon, web page contents, strongholds or attack targets in the game and so on.

The touch sensing device 11a and the image display unit 11b are arranged corresponding to each other and even can be integrated to one device. The touch sensing device 11a is used to detect the operating signal, such as a single-finger or multi-finger touch signal, which is due to the user touching the touch-control screen 11. The touch sensing device 11a can be a capacitive or a resistive touch sensing device, but the instant disclosure is not limited to the embodiments of the touch sensing device 11a.

Specifically, when the user touches the touch sensing device 11a by a single finger (or stylus), the touch signal is generated from the touch sensing device 11a and transmitted to the processing unit 10 in order to determine the location of the touch point and so the processing unit 10 can control the image display unit 11b to change the image according to the user's operation. Similarly, when the touch sensing device 11a is touched by multi-fingers, i.e. two fingers, the touch sensing device 11a can transmit a multi-finger touch signal to the processing unit 10 for processing.

The hover sensing device 12 can be used to receive the operating signal, such as a hover signal, inputted by the user. The hover sensing device 12 allows the user to operate the touch-control screen 11 without contacting the touch-control screen 11. That is to say, when at least one finger (or a stylus) hovers above the touch-control screen 11, a hover signal is generated by the hover sensing device 12. In addition, the hover sensing device 12 can transmit the hover signal to the processing unit 10 to determine the locations of the user's hovering finger(s) or stylus, i.e., all of coordinates which are respectively corresponding to a projection of each of the user's fingers or stylus on the touch-control screen 11. The hover sensing device 12 in the embodiment of the instant disclosure can be an electrostatic sensor, a thermal sensor or a light sensor, for instance. However, the instant disclosure is not limited to the embodiments of the hover sensing device 12.

Please refer to FIG. 1 again. The storage unit 13 is used to store a lot of auxiliary information respectively corresponding to each object or program codes which can be executed by the processing unit 10 to generate the auxiliary information corresponding to each object.

Overall, when the user inputs a command through the touch sensing device 11a, the operating signal is a touch signal. When the user inputs a command through the hover sensing device 12, the operating signal is a hover signal. The processing unit 10 can decide the coordinate on the touch-control screen 11 where the operating signal is generated, and determine whether the coordinate falls within the display range of the object. When the processing unit 10 asserts the coordinate falls within the display range of the object on the image display unit 11b, the corresponding program is executed by the processing unit 10 according to the type of the operating signal.

When the operating signal is the touch signal and the coordinate on the touch-control screen 11 where the touch signal is generated falls within the display range of the object, the processing unit 10 can open the selected object according to the touch signal and control the image display unit 11b to display the corresponding image. On the other hand, when the operating signal is the hover signal and the coordinate on the touch-control screen 11 where the hover signal is generated falls within the display range of the object, the processing unit 10 retrieves the auxiliary information corresponding to the object according to the hover signal and controls the touch-control screen 11 to display the auxiliary information corresponding to the object on the image display unit 11b. Notably, the program corresponding to the object is not executed by the processing unit 10 immediately.

The auxiliary information can be displayed by means of a dialog box, a prompt box, a table, a list, multimedia message (such as dynamic image, picture or voice message) and so on. The auxiliary information can include file format, file size, created date, modified date, the explanation of the software function or the software version, the path of the file and so forth. When the object is a stronghold or an attack target in the game, the auxiliary information can be the parameters corresponding to the stronghold or the attack target, such as race, weapon, money, equipment, number of people, health points, technical ability or attribute etc. In addition, the user can touch the touch-control screen 11 with one finger to select a text so that the processing unit 10 of the touch control display apparatus 1 defines the selected text as an object. When the processing unit 10 determines the coordinate where the hover signal is generated falls within the display range of the object, the processing unit 10 provides the translation text of the selected text to serve as the auxiliary information.

Additionally, in the embodiment of the instant disclosure, the touch control display apparatus 1 can optionally further include a speaker 14 which is coupled to the processing unit 10. For example, the speaker 14 is electrically connected to the processing unit 10 through a conductive wire. In one embodiment, the processing unit 10 can control the speaker 14 to play the voice message in order to provide the auxiliary information.

Notably, in the abovementioned embodiment, the hover signal is chosen to be an auxiliary information request signal to carry out the method for providing the auxiliary information, but does not limit the instant disclosure. In another embodiment as described as follow, the touch control display apparatus 1 cannot alternately include the hover sensing device 12, and the processing unit 10 of the touch control display apparatus 1 can determine the operating signal to be a single-finger or multi-finger touch signal in the beginning. When the operating signal is a multi-finger touch signal and all of the coordinates where the multi-finger touch signal is generated fall within the same display range of the object on the touch-control screen 11, the processing unit 10 determines the multi-finger touch signal is the auxiliary information request signal corresponding to the object. The details in this embodiment would be described in the following, and omitted herein.

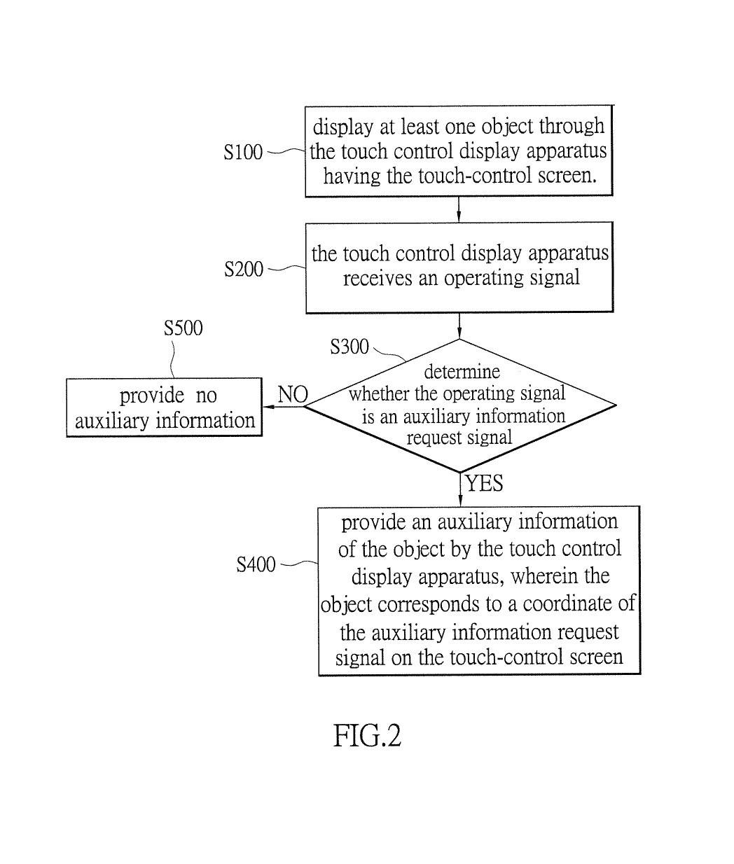

Please refer to FIG. 2, which illustrates a flow chart of a method for providing auxiliary information according to an embodiment of the instant disclosure. The method for providing auxiliary information according to an embodiment of the instant disclosure is capable of being executed in the touch control display apparatus having a touch-control screen. For example, the touch control display apparatus 1 as shown in FIG. 1 and the touch control display apparatus without the hover sensing device 12.

Firstly, in step S100, at least one object is displayed by the touch control display apparatus having the touch-control screen.

Subsequently, in step S200, the touch control display apparatus receives an operating signal. In the instant embodiment, the operating signal is inputted by the user with one or more fingers through a touch sensing device or hover sensing device.

Subsequently, in step S300, whether the operating signal is an auxiliary information request signal is determined. Specifically, after detecting the operating signal, the touch sensing device or the hover sensing device transmits the operating signal to the processing unit. The step S300 can be performed by processing unit through software or firmware. The software or firmware can be programmed in the register of the processing unit or stored in the storage unit. In addition, the examples for determining whether the operating signal is the auxiliary information request signal will be described in more detail in the following.

When the operating signal is the auxiliary information request signal, the method for providing auxiliary information can proceed to step S400. When the operating signal is not the auxiliary information request signal, the method for providing auxiliary information can proceed to step S500.

In step S400, the touch control display apparatus provides auxiliary information of the object, and the object corresponds to a coordinate of the auxiliary information request signal on the touch-control screen. In one embodiment, the touch control display apparatus provides the auxiliary information of the object through the touch-control screen and/or a speaker. In step S500, the auxiliary information is not provided.

In one embodiment, the processing unit controls the image display unit to show a window, such as a prompt box or a dialog box, to present the auxiliary information of the object. The processing unit can control the image display unit to provide the auxiliary information to the user by means of presenting a text, a table, a list, an address of a hyperlink, a static image, an animation, a multimedia message and so on. For example, if the object corresponds to a photograph application, the auxiliary information presented in the window can include a function explanation of the application, a path, a version, a created date, a file size, and the combination thereof.

The aforementioned steps for determining whether the operating signal is the auxiliary information request signal can be designed dependent on practical situation by a software developer or a firmware developer, and the program codes corresponding to the steps can be recorded in a readable non-volatile memory device.

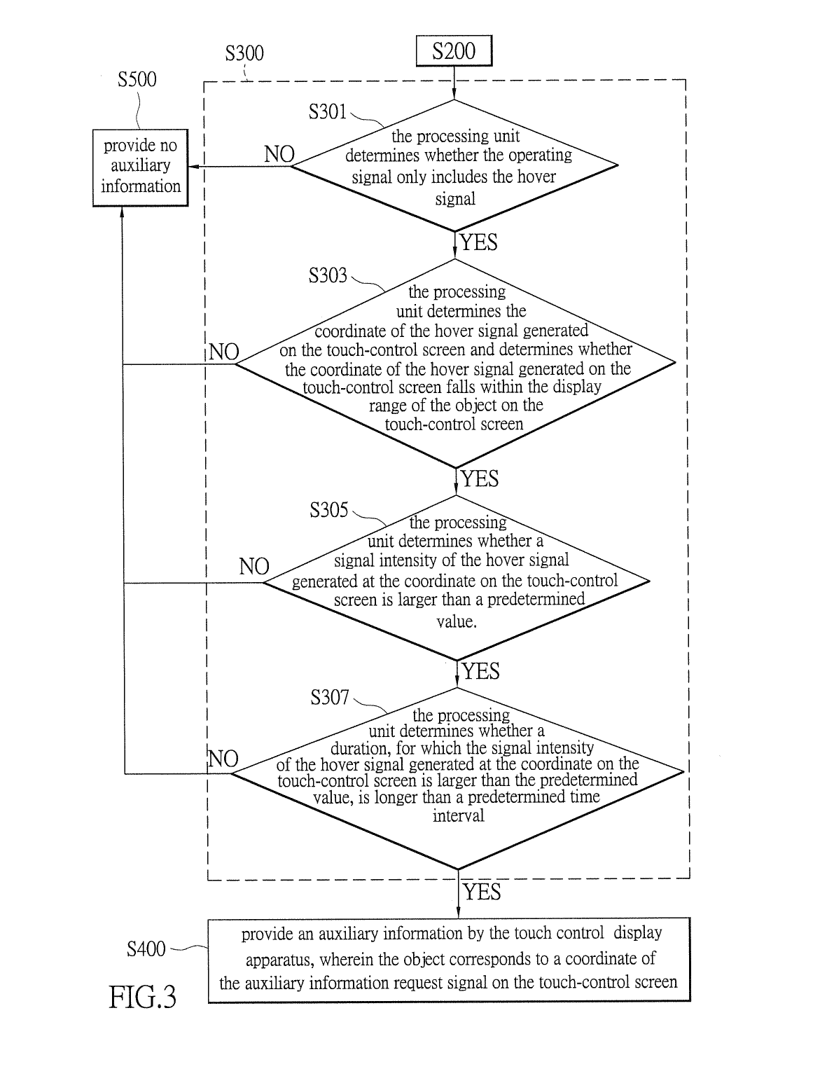

Please refer to FIG. 3, which shows a flow chart for determining whether the operating signal is an auxiliary information request signal according to an embodiment of the instant disclosure. In the instant embodiment, the touch control display apparatus includes the hover sensing device to detect the hover signal. When the operating signal is the touch signal, the processing unit cannot control the image display unit to present the auxiliary information. Only when the operating signal is the hover signal, the processing unit can further determine whether or not the image display unit presents the auxiliary information.

Accordingly, in the instant embodiment, the process that determines whether the operating signal is the auxiliary information request signal is described in more detail in the following. In step S301, the processing unit determines whether the operating signal only includes the hover signal. When the operating signal only include the hover signal, the process that determines whether the operating signal is the auxiliary information request signal proceeds to step S303. If the operating signal is the touch signal or includes both of the touch signal and the hover signal, the process that determines whether the operating signal is the auxiliary information request signal proceeds to step S500.

In step S303, the processing unit determines the coordinate of the hover signal generated on the touch-control screen and determines whether the coordinate of the hover signal generated on the touch-control screen falls within the display range of the object on the touch-control screen.

After receiving the operating signal, the processing unit first determines that the operating signal comes from the touch sensing device or from the hover sensing device. If the processing unit asserts the operating signal comes from the touch sensing device, the operating signal is the touch signal. Assuming that the user's finger touches the touch sensing device, the touch signal is detected by the touch sensing device and then transmitted to the processing unit in order to determine the coordinate of the touch signal on the touch-control screen.

Additionally, the processing unit can determine whether the coordinate of the touch signal falls within the display range of the object. If the coordinate of the touch signal falls within the display region of the object, the processing unit will open the selected object instead of providing the auxiliary information of the selected object.

On the other hand, if the processing unit asserts the operating signal is provided by the hover sensing device, the operating signal is the hover signal. That is to say, when the user's finger hovers over the touch-control screen, the processing unit can determine whether a projecting position of an orthographic projection of the user's finger on the touch-control screen falls within the display range of the subject according to a coordinate of the hover signal on the touch-control screen.

When the coordinate of the hover signal on the touch-control screen falls out of the display range of the object, i.e., the projecting position of the orthographic projection of the user's finger does not fall within the display range of the object, the process of determining whether the operating signal is the auxiliary information request signal proceeds to step S500. That is, the auxiliary information would not be displayed on the touch-control screen. When the coordinate of the hover signal on the touch-control screen falls within the display range of the object, the process of determining whether the operating signal is the auxiliary information request signal proceeds to step S305.

In step S305, the processing unit determines whether a signal intensity of the hover signal generated at the coordinate on the touch-control screen is larger than a predetermined value. When the signal intensity is larger than the predetermined value, the process of determining whether the operating signal is the auxiliary information request signal proceeds to step S307. When the signal intensity is less than the predetermined value, the process of determining whether the operating signal is the auxiliary information request signal proceeds to step S500.

The hover signal detected by the hover sensing device can due unintentional contact. Accordingly, in step S305, the processing unit can determine whether the hover signal detected by the hover sensing device is available or unavailable according to the value of the signal intensity.

Specifically, the larger a distance between the user's finger and the touch-control screen, the weaker the signal intensity detected by the hover sensing device. Thus, after receiving the hover signal, the processing unit can determine whether the hover signal detected by the hover sensing device is caused by the unintentional contact or not according to determination on whether the signal intensity is larger than the predetermined value.

When the signal intensity is less than the predetermined value, the processing unit can assert the distance between the user's finger and the touch-control screen is larger than a preset distance. Upon the circumstance, the processing unit can determine the signal is not the operating signal that the user intends to input. On the contrary, when the processing unit asserts the signal intensity of the hover signal is larger than the predetermined value, the hover signal is an available operating signal ∘

In step S307, the processing unit determines whether a duration, for which the signal intensity of the hover signal generated at the coordinate on the touch-control screen is larger than the predetermined value, is longer than a predetermined time interval. When the duration is shorter than the predetermined time interval, the process of determining whether the operating signal is the auxiliary information request signal proceeds to step S500. When the duration is longer than the predetermined time interval, the process of determining whether the operating signal is the auxiliary information request signal proceeds to step S400

If the orthographic projection of the user's finger just passes through the display range of the object rather than staying within the display range of the object for as long as the predetermined time interval, the processing unit will not process the hover signal as the auxiliary information request signal even if the hover sensing device detects the hover signal. In this situation, the processing unit cannot control the image display unit or the speaker to provide the auxiliary information.

When the hover signal is generated at the display range of the object for a certain period of time, and if the duration, for which the signal intensity of the hover signal is larger than the predetermined value, is longer than the predetermined time interval, the processing unit will process the hover signal as the auxiliary information request signal. When the processing unit confirms that the operating signal received by the touch control display apparatus is the auxiliary information request signal, the possibility that the processing unit erroneously processes the hover signal as the auxiliary information request signal can be decreased by performing the steps S305 and S307.

In another embodiment, if the possibility of the erroneous judgment falls within an acceptable range, the steps S305 and S307 can be optionally omitted. Alternately, only step S307 is omitted. That is, the function of attenuating the erroneous judgment can be adjusted, such as adjusting the predetermined value of the signal intensity or the time interval of the duration, or completely turning off the attenuating function according to the practical demands.

It is worth noting that the hover sensing device can continuously detect the coordinate of the hover signal on the touch-control screen so that the processing unit can persistently determine whether the coordinate of the hover signal on the touch-control screen falls within the display range of the object. That is, the hover sensing device can persistently detect whether the coordinate of the orthographic projection of the user's finger on the touch-control screen stays within the display range of the object on the touch-control screen for the duration where the coordinate of the orthographic projection stays within the display range. When the orthographic projection of the user's finger moves out of the display range of the object, the hover signal generated within the display range of the object cannot be detected and received by the processing unit. Accordingly, the processing unit cannot provide the auxiliary information through the image display unit or the speaker.

In another embodiment, when the user is reading the auxiliary information, the user can scroll through the auxiliary information in a window by moving the finger up and down or moving the finger left and right for the desired scrolling direction. In other words, when the projecting position of the orthographic projection of the user's finger is moved out of the display range of the object and into a range in the window on the touch-control screen, the coordinate of the hover signal also moves into the range of the window from the display range of the object. In this case, the processing unit can control the auxiliary information presented in the window to be scrolled according to the scrolling direction of the coordinate of the hover signal within the range of the window.

Additionally, after viewing the auxiliary information of the object, the user can decide whether or not to input the touch signal through the touch sensing device and open the corresponding object. Notably, when the user selects the object through the touch sensing device, the user's finger also can be detected by the hover sensing device. Accordingly, the processing unit can receive both of the touch signal and the hover signal. Only at this point, the processing unit opens the selected object instead of continuously providing the auxiliary information corresponding to the object through the image display unit or the speaker.

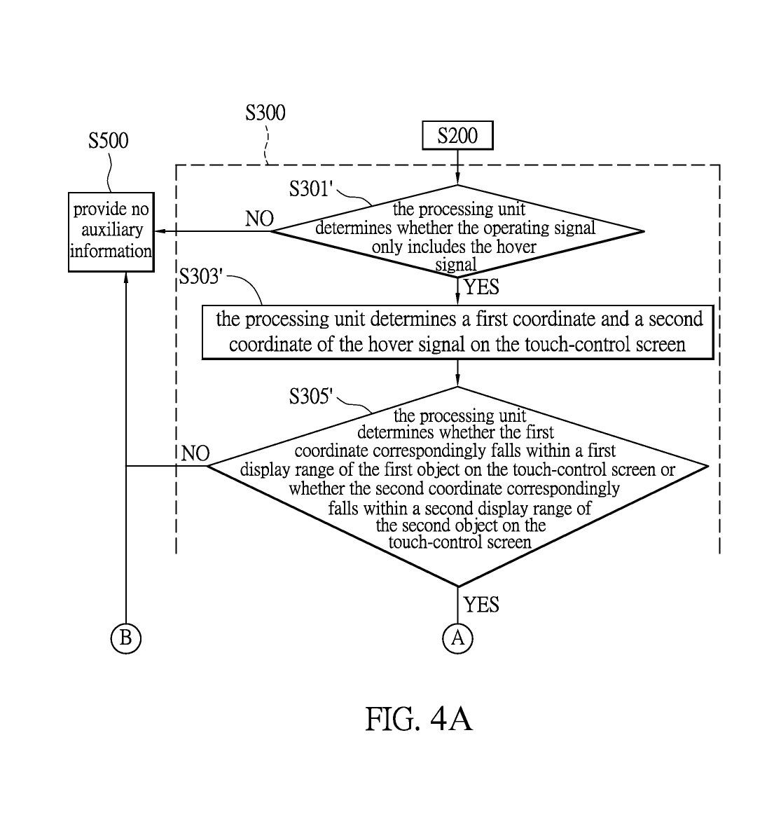

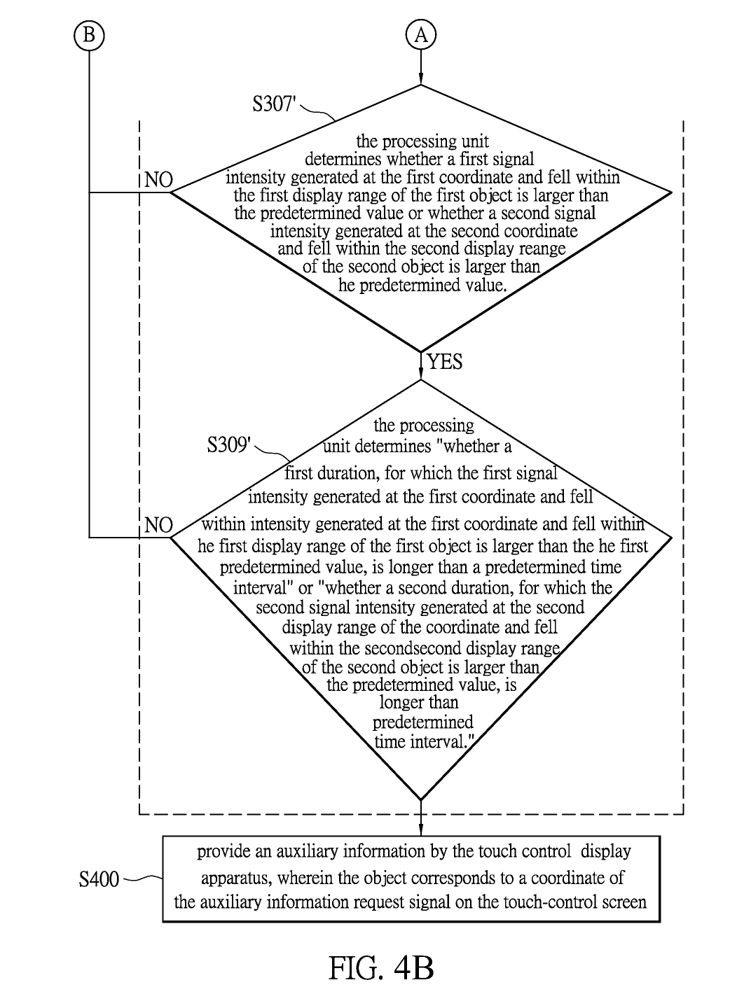

Please refer to FIGS. 4A and 4B, which illustrate a flow chart for determining whether the operating signal is an auxiliary information request signal according to another embodiment of the instant disclosure. In the instant embodiment, the operating signal is a multi-finger hover signal. Additionally, in the instant embodiment, the touch control display apparatus can display at least a first object and a second object through the touch-control screen. And also, the processing unit can decide whether to provide a first auxiliary information of the first object and a second auxiliary information of the second object according to the determination on whether or not the multi-finger hover signal is an auxiliary information request signal. The process of determining whether or not the multi-finger hover signal is an auxiliary information request signal will be described in more detail as follow.

It should be first noted that the multi-finger hover signal is defined by the operating signal from the user with at least two user's fingers simultaneously hovering over the touch-control screen. Two of the user's fingers are normally projected on the touch-control screen, and the hover sensing device can detect two coordinates of two projecting positions on the touch-control screen according to two orthographic projections of the two fingers. Accordingly, in step S301′, the processing unit first determines whether the operating signal only includes the hover signal. When the operating signal only includes the hover signal, the process of determining whether or not the operating signal is an auxiliary information request signal proceeds to step S303′. When the operating signal is the touch signal or includes both of the hover signal and the touch signal, the process of determining whether the operating signal is an auxiliary information request signal proceeds to step S500.

In step S303′, the processing unit determines a first coordinate and a second coordinate of the hover signal on the touch-control screen. In step S305′, the processing unit determines whether the first coordinate correspondingly falls within a first display range of the first object on the touch-control screen or whether the second coordinate correspondingly falls within a second display range of the second object on the touch-control screen. When neither the first coordinate correspondingly falls within the first display range of the first object nor the second coordinate falls within the second display range of the second object on the touch-control screen, the process of determining whether the operating signal is an auxiliary information request signal proceeds to step S500. When the first coordinate correspondingly falls within the first display range of the first object on the touch-control screen or the second coordinate correspondingly falls within the second display range of the second object on the touch-control screen, the process of determining whether the operating signal is an auxiliary information request signal proceeds to step S307′.

In step S307′, the processing unit determines whether a first signal intensity generated at the first coordinate and fell within the first display range of the first object is larger than a predetermined value or whether a second signal intensity generated at the second coordinate and fell within the second display range of the second object is larger than the predetermined value. When neither the first signal intensity generated at the first coordinate and fell within the first display range of the first object nor the second signal intensity generated at the second coordinate and fell within the second display range of the second object is larger than the predetermined value, the process of determining whether the operating signal is an auxiliary information request signal proceeds to step S500. When the first signal intensity generated at the first coordinate and fell within the first display range of the first object is larger than the predetermined value or the second signal intensity generated at the second coordinate and fell within the second display range of the second object is larger than the predetermined value, the process of determining whether the operating signal is an auxiliary information request signal proceeds to step S309′.

In step S309′, the processing unit determines “whether a first duration, for which the first signal intensity generated at the first coordinate and fell within the first display range of the first object is larger than the predetermined value, is longer than a predetermined time interval” or “whether a second duration, for which the second signal intensity generated at the second coordinate and fell within the second display range of the second object is larger than the predetermined value, is longer than predetermined time interval.” When neither the first duration nor the second duration is longer than the predetermined time interval, the process of determining whether the operating signal is the auxiliary information request signal proceeds to step S500. When one of the first duration or the second duration is longer than the predetermined time interval, the process of determining whether the operating signal is the auxiliary information request signal proceeds to step S400. That is, the multi-finger hover signal is determined to be the auxiliary information request.

In step S400, the touch control display apparatus provides the auxiliary information of the object. Assuming that the first object corresponds to the first auxiliary information, and the second object corresponds to the second auxiliary information, if both of the first duration and the second duration are longer than the predetermined time interval, the touch control display apparatus will provide the first and second auxiliary information simultaneously. If only the first duration is longer than the predetermined time interval, the touch control display apparatus will provide the first auxiliary information. If only the second duration is longer than the predetermined time interval, the touch control display apparatus will provide the second auxiliary information corresponding to the second object.

In the embodiment of the instant disclosure, the first and second auxiliary information are summarized in the same window by the touch control display apparatus and then displayed to the user through the image display unit. In another embodiment of the instant disclosure, the first and second auxiliary information are summarized into a single format by the touch control display apparatus and then displayed to the user through the image display unit. In another embodiment of the instant disclosure, the first and second auxiliary information can be respectively displayed in different windows by touch control display apparatus through the image display unit.

As mentioned previously, in another embodiment of the instant disclosure, the touch control display apparatus cannot include the hover sensing device. When the touch control display apparatus does not include the hover sensing device, the user inputs the auxiliary information request signal through the touch sensing device. The user can touch the same object displayed on the touch-control screen with two fingers for a duration so that the auxiliary information request signal is inputted to the touch control display apparatus.

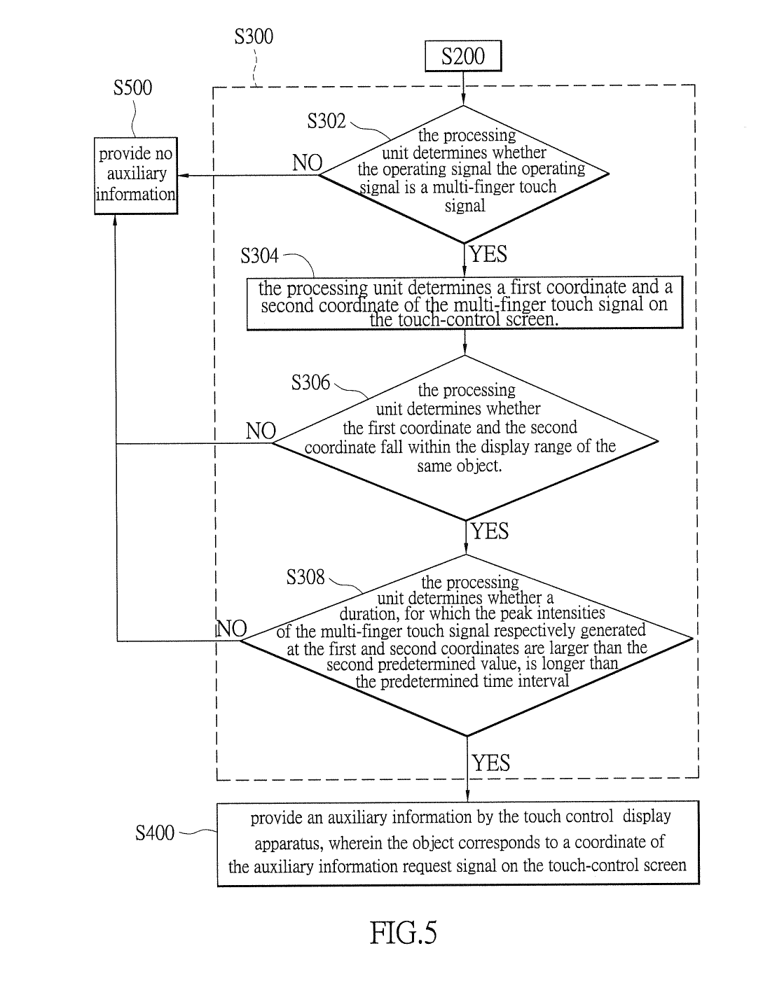

Please refer to FIG. 5, which shows a flow chart for determining whether the operating signal is an auxiliary information request signal according to another embodiment of the instant disclosure. In step S302, the processing unit determines whether the operating signal is a multi-finger touch signal.

Specifically, in the step of determining whether the operating signal is a multi-finger touch signal, the processing unit can first determine whether the operating signal has multiple peaks which respectively correspond to different coordinates on the touch-control screen. When the operating signal has multiple peaks respectively corresponding to different coordinates on the touch-control screen, the operating signal is determined to be a multi-finger touch signal.

In another embodiment, the operating signal can have only one peak. When an intensity of the operating signal is larger than the first predetermined value, the processing unit can determine that the operating signal is the multi-finger touch signal. In the embodiment of the instant disclosure, take the operating signal has multiple peaks as an example. In addition, the technique for determining whether the operating signal is a multi-finger touch signal can be carried out by any well-known means, which should not be used to limit the scope of the instant invention.

If the operating signal has only one peak and the intensity is smaller than the first predetermined value but larger than a second predetermined value, the processing unit will determine that the operating signal is a single-finger touch signal. When the operating signal is the single-finger touch signal, the process of determining whether the operating signal is an auxiliary information request signal proceeds to step S500. For example, when the processing unit determines that the operating signal is the single-finger touch signal, the processing unit can further determine whether a coordinate of the single-finger touch signal on the touch-control screen falls within the display range of the object. If yes, the processing unit will open the corresponding object instead of providing the auxiliary information corresponding to the object.

In step S304, the processing unit decides a first coordinate and a second coordinate of the multi-finger touch signal on the touch-control screen. Subsequently, in step S306, the processing unit determines whether the first coordinate and the second coordinate fall within the display range of the same object. When the first and second coordinates are not within the display range of the same object, the method for providing auxiliary information proceeds to step S500. When the first and second coordinates fall within the display range of the same object, the method for providing auxiliary information proceeds to step S308

In step S308, the processing unit determines whether a duration, for which the peak intensities of the multi-finger touch signals respectively generated at the first and second coordinates are larger than the second predetermined value, is longer than the predetermined time interval. When the duration, for which the peak intensities of the multi-finger touch signals respectively generated at the first and second coordinates are larger than the second predetermined value, is shorter than the predetermined time interval, the method for providing auxiliary information proceeds to step S500. In other words, the user can only want to zoom in or out of a picture or content instead of previewing the auxiliary information. Accordingly, the processing unit would not present the auxiliary information via the touch-control screen.

In addition, when the duration, for which the peak intensities of the multi-finger touch signals respectively generated at the first and second coordinates are larger than the second predetermined value, is larger than the predetermined time interval, the processing unit determines that the multi-finger touch signal is the auxiliary information request signal, and the method for providing auxiliary information proceeds to step S400. In step S400, the touch control display apparatus provides the auxiliary information of the object, and the object corresponds to the first and second coordinates of the auxiliary information request signal on the touch-control screen.

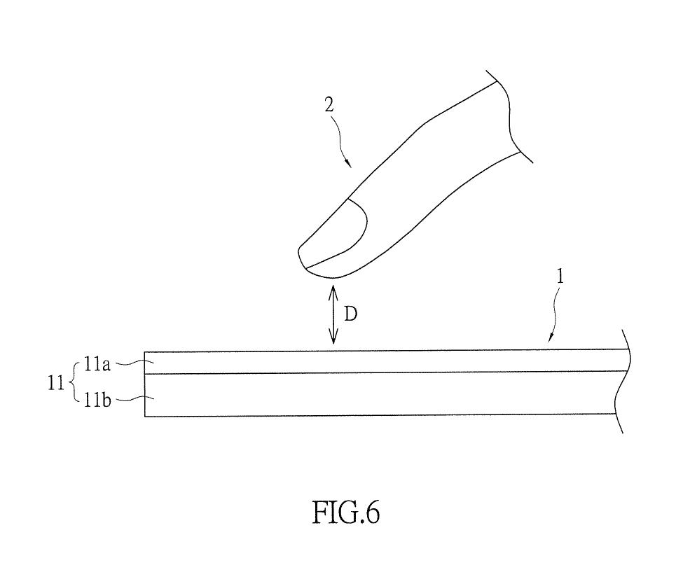

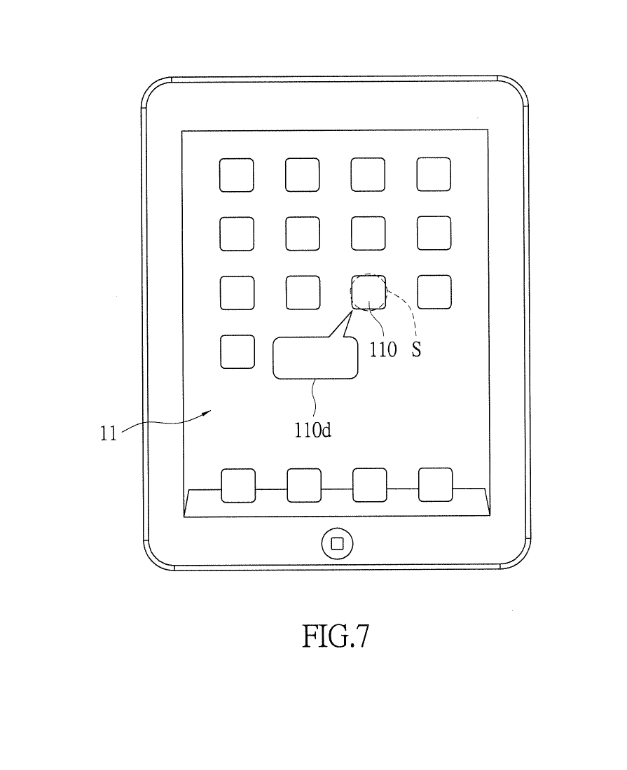

Take the hover signal as an example, the method for providing the auxiliary information executed in the touch control display apparatus is further described. Please refer to FIG. 1, FIG. 6 and FIG. 7. FIG. 6 shows a lateral view of the touch control display apparatus shown in FIG. 1 in use state, and FIG. 7 shows a schematic diagram of the touch control display apparatus in which the method for providing auxiliary information is executed according to an embodiment of the instant disclosure.

Please refer to FIG. 6. When the user hovers finger 2 (or stylus) over the touch-control screen 11 for a duration, and the distance D between the user's finger 2 and the touch sensing device 11a is smaller than a preset distance (but the value of D is not equal to zero), the hover sensing device 12 can detect the position of the finger 2 relative to the touch-control screen 11 and generate the hover signal. When the user touches the touch sensing device 11a with the finger to input a command, the operating signal is a touch signal.

As shown in FIG. 7, the touch-control screen 11 is used to display a plurality of the object 110, which can respectively corresponds to different application or files, such as schedule, address list, video player application, music player application, photograph application, picture documents or the combination of many programs. For example, the object 110 corresponds to a photograph application and has a display range S on the touch-control screen 11. That is to say, when the operating signal is determined to be a touch signal, and a coordinate of the touch signal on the touch-control screen 11 falls within the display range S of the object 110 on the touch-control screen 11, the processing unit 10 can execute the photograph application so as to enable the user to take photograph or record video.

Furthermore, it is assumed that the projecting position of the orthographic projection of the finger 2 on the touch-control screen 11 is located in the display range S, as shown in FIG. 6. When receiving the hover signal transmitted by the hover sensing device 12, the processing unit 10 can determine whether the coordinate of the hover signal falls within the display range S on the touch-control screen 11 and determine whether the hover signal is the auxiliary information request signal by following the method as shown in FIG. 3.

After the processing unit 10 confirms that the hover signal is the auxiliary information request signal, the processing unit 10 controls the touch-control screen 11 to display the window 110d to provide the user with the auxiliary information corresponding to the object 110. The auxiliary information can include the explanation of the software function, the path of the file, the version, the created date, the file size or the combination thereof.

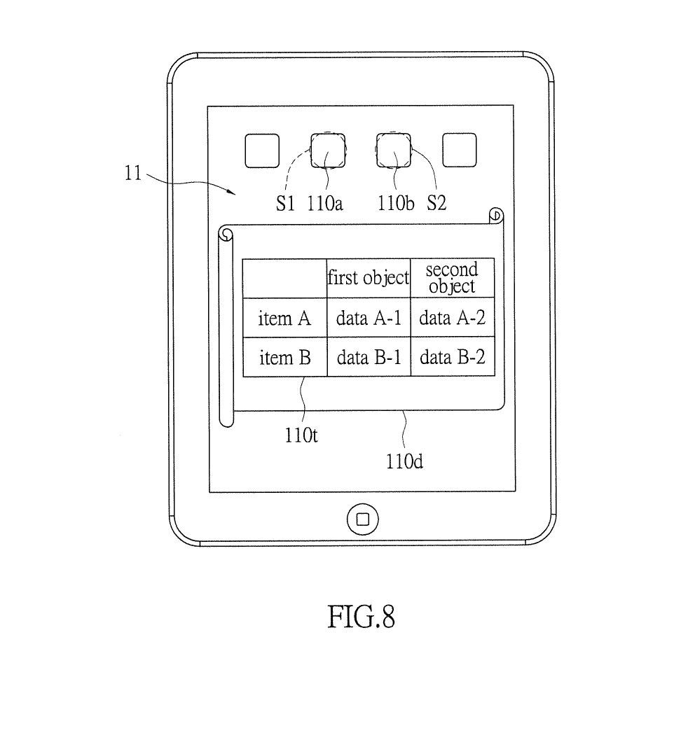

Next, FIG. 8 provides an example for the description of the method for providing auxiliary information executed in the touch control display apparatus. As shown in FIG. 8, a first object 110a and a second object 110b are displayed by the touch-control screen 11. The first object 110a has a first display range S1 corresponding to the touch-control screen 11, and the second object 110b has a second display range S2 corresponding to the touch-control screen 11

In the instant embodiment, it is assumed that the user hovers two fingers respectively over the first object 110a and second object 110b. In other words, the projecting positions of the orthographic projections of the user's fingers on the touch-control screen 11 are respectively aligned with the first display range S1 of the first object 110a and the second display range S2 of the second object 110b

After receiving the multi-finger hover signal transmitted by the hover sensing device 12, the processing unit 10 determines whether the first coordinate and the second coordinate of the multi-finger hover signal respectively fall within the first display range S1 of the first object 110a and the second display range S2 of the second object 110b. In addition, the processing unit 10 determines whether the hover signal is the auxiliary information request signal according to the process described in FIGS. 4A and 4B.

Accordingly, the processing unit 10 controls the touch-control screen 11 to present the auxiliary information of the first object 110a and the second object 110b. In the embodiment shown in FIG. 8, the auxiliary information of the first object 110a and the second object 110b are summarized in the table 110t and displayed in the same window 110d. For example, the processing unit 10 can summarize and list the same items in the auxiliary information of the first object 110a and second object 110b from the table 110t so that the user can easily compare the auxiliary information of the first object 110a with that of the second object 110b.

The abovementioned method that provides auxiliary information can be executed in the touch control display apparatus 1. The touch control display apparatus 1 can be a portable electronic product having the touch-control screen, such as smart phone, tablet, PDA, laptop, camera, e-book or media player, or can be an electronic apparatus having the touch-control screen, such as an inspecting equipment, an experimental equipment or a production equipment, etc. In another embodiment, the touch control display apparatus 1 can be a gaming machine, a guiding machine, or an auto teller machine and so on, which can be set in store, museum or roadside. The method for providing auxiliary information according to the embodiments of the instant disclosure can be applied in the abovementioned electronic apparatus having the touch-control screen.

In summary, the method for providing auxiliary information and the touch control display apparatus using the same according to the embodiments of the instant disclosure enable the user to input the auxiliary information request signal and preview the auxiliary information of the application or the files corresponding to the object before applications or files are executed or opened using the touch control display interface. The auxiliary information can provide user with a basis for determining whether to execute the application or open the files. The method for providing auxiliary information can be implemented in different operation interface, such as the equipment operation interface, software operation interface or game operation interface, all of which can further help the user to quickly familiarize with the operation of the equipment or the software. Furthermore, the method for providing auxiliary information in the embodiment of the instant disclosure can also save search time for users when browsing the desirable program in the function menu.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A method for providing auxiliary information executed in a touch control display apparatus having a touch-control screen, wherein the method comprises:
receiving an operating signal;
determining whether the operating signal is an auxiliary information request signal; and
when the operating signal is the auxiliary information request signal, a first auxiliary information of a first object is provided, wherein the first object corresponds to a first coordinate of the auxiliary information request signal on the touch-control screen.

2. The method for providing auxiliary information according to claim 1, wherein the step of determining whether the operating signal is the auxiliary information request signal comprises:
determining whether the operating signal only includes a hover signal;
determining the first coordinate of the hover signal generated on the touch-control screen when the operating signal only includes the hover signal;
determining whether the first coordinate of the hover signal generated on the touch-control screen falls within a first display range of the first object on the touch-control screen; and
confirming the hover signal is the auxiliary information request signal when the first coordinate of the hover signal generated on the touch-control screen falls within the first display range of the first object.

3. The method for providing auxiliary information according to claim 2, wherein the step of determining whether the operating signal is the auxiliary information request signal further comprises:
when the first coordinate falls within the first display range of the first object on the touch-control screen, determining whether a signal intensity of the hover signal generated at the first coordinate on the touch-control screen is larger than a predetermined value;
when the signal intensity of the hover signal generated at the first coordinate on the touch-control screen is larger than the predetermined value, determining whether a duration, for which the signal intensity of the hover signal generated at the first coordinate on the touch-control screen is larger than the predetermined value, is longer than a predetermined time interval; and
when the duration, for which the signal intensity of the hover signal generated at the first coordinate on the touch-control screen is larger than the predetermined value, is longer than the predetermined time interval, confirming the hover signal is the auxiliary information request signal.

4. The method for providing auxiliary information according to claim 2, when the operating signal includes a touch signal, the touch-control screen does not display the first auxiliary information of the first object.

5. The method for providing auxiliary information according to claim 1, further comprising:
providing a second auxiliary information of a second object, wherein the second object corresponds to a second coordinate of the auxiliary information request signal on the touch-control screen.

6. The method for providing auxiliary information according to claim 5, wherein the operating signal is a multi-finger hover signal.

7. The method for providing auxiliary information according to claim 6, wherein the step of determining whether the operating signal is the auxiliary information request signal comprises:
determining the first coordinate and the second coordinate of the multi-finger hover signal on the touch-control screen;
determining whether the first coordinate and the second coordinate respectively fall within a first display range of the first object and a second display range of the second object on the touch-control screen;
determining whether a first signal intensity of the multi-finger hover signal generated at the first coordinate fell and within the first display range of the first object is larger than a predetermined value, and whether a second signal intensity of the multi-finger hover signal generated at the second coordinate and fell within the second display range of the second object is larger than the predetermined value when the first coordinate correspondingly falls within the first display range of the first object or the second coordinate correspondingly falls within the second display range of the second object on the touch-control screen;
determining whether the first signal intensity generated at the first coordinate larger than the predetermined value has a first duration longer than a predetermined time interval, and whether the second signal intensity generated at the second coordinate larger than the predetermined value has a second duration longer than the predetermined time interval when both of the first signal intensity and the second signal intensity of the multi-finger hover signal respectively generated at the first coordinate and the second coordinate are larger than the predetermined value; and
confirming the multi-finger hover signal is the auxiliary information request signal when both of the first duration and the second duration are larger than the predetermined time interval.

8. The method for providing auxiliary information according to claim 5, wherein the first auxiliary information and the second auxiliary information are displayed in a same window.

9. The method for providing auxiliary information according to claim 5, wherein the first auxiliary information and the second auxiliary information are displayed in different windows.

10. The method for providing auxiliary information according to claim 1, wherein the step of determining whether the operating signal is the auxiliary information request signal comprises:
determining whether the operating signal is a multi-finger touch signal;
determining a first coordinate and a second coordinate of the multi-finger touch signal on the touch-control screen when the operating signal is a multi-finger touch signal;
determining whether the first coordinate and the second coordinate fall within a first display range of the first object on the touch-control screen;
determining whether the multi-finger touch signal having the peak intensities respectively generated at the first and second coordinates and larger than a predetermined value has a duration longer than a predetermined time interval when the first coordinate and the second coordinate fall within the first display range of the first object; and
confirming the multi-finger touch signal is auxiliary information request signal when the duration is longer than the predetermined time interval.

11. The method for providing auxiliary information according to claim 1, wherein the first object is an icon of a toolbar or a system menu, a web page content, a game stronghold or a game attack target.

12. The method for providing auxiliary information according to claim 1, wherein the first auxiliary information is a text, a table, a list, an address of a hyperlink, a static image, an animation or a multimedia message.

13. A touch control display apparatus comprising:
a touch-control screen for displaying at least one object; and
a processing unit electrically connected to the touch-control screen for receiving and processing at least one auxiliary information request signal, wherein the processing unit controls the touch-control screen to display an auxiliary information of the object according to the auxiliary information request signal, and the object corresponds to a coordinate of the auxiliary information request signal on the touch-control screen.

14. The touch control display apparatus according to claim 13, further comprising a hover sensing device for receiving the auxiliary information request signal.

15. The touch control display apparatus according to claim 14, wherein the hover sensing device is an electrostatic sensor, a thermal sensor or a light sensor.

16. The touch control display apparatus according to claim 14, wherein the auxiliary information request signal is a hover signal.
